(19) United States
(12) Patent Application Publication
(10) Pub. No.: US 2018/0302787 A1
(43) Pub. Date: Oct. 18, 2018

(54) SYSTEMS AND METHODS FOR SECURELY PROVISIONING HYPERTEXT TRANSFER PROTOCOL SECURE (HTTPS) PINS TO A MOBILE CLIENT

(71) Applicant: Synchronoss Technologies, Inc., Bridgewater, NJ (US)

(72) Inventors: Sean Boylan, Ballinahalla (IE); Darren Redmond, Dublin 3 (IE)

(21) Appl. No.: 15/486,703

(22) Filed: Apr. 13, 2017

(51) Int. Cl. H04W 12/04; H04L 29/06; H04L 9/30; H04L 9/32; H04L 29/08

(52) U.S. Cl. CPC H04W 12/04; H04L 63/062; H04L 9/30; H04L 9/3247; H04L 67/42; H04L 9/3236; H04L 63/0823; H04L 67/02; H04L 9/3263

(57) ABSTRACT

Systems and methods for securely provisioning HTTPS pins to a mobile client are provided herein. In some embodiments, the method may comprise receiving, at a mobile client, a digitally signed mobile client configuration file, wherein the mobile client configuration file comprises one or more URLs and one or more key pins associated with services available from the one or more URLs; retrieving a public key from a public key store; verifying a digital signature of the mobile client configuration file using the public key; and storing the key pins on the mobile client when the digital signature is verified.

### BACKGROUND OF THE INVENTION

### Field of the Invention

Embodiments of the present invention relate generally to establishing secure network connections and, more particularly, to methods and systems for provisioning mobile client key pinning using a digital signature.

### Description of the Related Art

Client-server applications communicate across a network in a way designed to prevent eavesdropping and tampering, for example using a Hypertext Transfer Protocol Secure (HTTPS) connection. A man-in-the-middle attack (MITM) is a type of cyberattack where a malicious actor inserts him/herself into a conversation between two parties (i.e., the client and the server), impersonates both parties and gains access to information that the two parties were trying to send to each other. A MITM attack allows a malicious actor to intercept, send and receive data meant for someone else, or not meant to be sent at all, without either outside party knowing until it is too late.

When opening a HTTPS connection between a client and a server, the identity of the server is verified using the server's certificate in order to protect against Man-in-the-middle-attacks. In such connections, clients and servers exchange certificates which are issued and verified by a trusted third party called a certificate authority (CA). If the original key to authenticate this CA has not been itself the subject of a MITM attack, then the certificates issued by the CA may be used to authenticate the messages sent by the owner of that certificate. Use of mutual authentication, in which both the server and the client validate the other's communication, covers both ends of a MITM attack, though the default behavior of most connections is to only authenticate the server.

In addition, with mobile devices, the mobile device HTTPS protocol stack does not actually authenticate the server. Rather, the protocol stack only performs the encryption of the data. Therefore, MITM attacks on connections between mobile clients and server is possible.

HTTP Public Key Pinning helps prevent a MITM attack in which a CA itself is compromised. In key pinning, a hash of the server's certificate is generated and sent to a client during the first transaction between the client and the server. The client stores the hash as the key pin. During the establishment of a HTTPS connection, the client receives the certificate from the server, generates the hash, and determines whether the generated hash matches the key pin previously stored on the client. The challenge in key pinning is getting the key pins to a mobile client without the pins being compromised.

Accordingly, there exists a need in the art for methods and systems for securely provisioning HTTPS key pins to a mobile client.

### SUMMARY OF THE INVENTION

Systems and methods for providing mobile client key pinning using a digital signature are provided herein. In some embodiments, the method for providing mobile client key pinning using a digital signature may comprise accessing, at a server, a secure server certificate; generating a key pin for the secure server certificate; storing the key pin in a mobile client configuration file for a mobile client; and digitally signing the mobile client configuration file.

In some embodiments, the method for providing mobile client key pinning using a digital signature may comprise receiving, at a mobile client, a digitally signed mobile client configuration file, wherein the mobile client configuration file comprises one or more URLs and one or more key pins associated with services available from the one or more URLs; retrieving a public key from a public key store; verifying a digital signature of the mobile client configuration file using the public key; and storing the key pins on the mobile client when the digital signature is verified.

In some embodiments, the system for establishing an HTTPS connection may comprise a server comprising a memory for storing a plurality of secure server certificates and one or more mobile client configuration files; and a mobile client configured to perform a method to request to establish an HTTPS connection to the server; receive a secure server certificate; extract a subject public key information (SPKI) section of the secure server certificate; generate a hash from the extracted SPKI section of the secure server certificate; base64-encode the generated hash; compare the base64-encoded hash to a key pin stored on the mobile client, wherein the key pin is associated with a URL associated with the server; and establish the HTTPS connection between the mobile client and the server when the key pin and base64-encoded hash match.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system for securely provisioning HTTPS pins to a mobile client in accordance with one or more embodiments of the invention;

FIG. 2 depicts a method for creating a mobile client configuration file for distribution to a mobile client, in accordance with one or more embodiments of the invention;

FIG. 3 is a flow diagram of a method for securely provisioning HTTPS pins to a mobile client, in accordance with one or more embodiments of the invention;

FIG. 4 is a flow diagram of method for opening an HTTPS connection between a mobile client and a server, in accordance with one or more embodiments of the invention;

FIGS. 5A and 5B are an exemplary sncConfig file and an exemplary mobile client configuration file, respectively, for use in a single data center environment, in accordance with one or more embodiments of the invention;

FIG. 6 is an exemplary HTTP response message returned in response to a request for a mobile client configuration file for use in a multi-data center environment, in accordance with one or more embodiments of the invention; and

FIG. 7 is a depiction of a computer system that can be utilized in various embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments consistent with the present invention are directed to methods and systems for securely provisioning HTTPS pins to a mobile client. A mobile client configuration file is created that includes key pins associated with secure server certificates. A certificate is associated with a server at a universal resource locator (URL). One or more pins may be associated with one or more services at the server. The pins are created by generating a hash, for example, a 256-hash on a subject public key information (SPKI) section of the secure server certificate. The hash is then base64-encoded. The result of the base64-encoding is the key pin for the certificate. One or more key pins are saved in the mobile client configuration file. The mobile client configuration file is then digitally signed by a certificate authority hosted or managed by the server.

When a user on a mobile client starts their mobile application that is associated with the server (for example, a cloud-based content sharing server), the mobile application retrieves the mobile client configuration file from the server. A public key is retrieved from a public key store server. The digital signature of the mobile client configuration file is verified using the public key. If the digital signature is verified, then the mobile app knows that the mobile client configuration file came from where it was expected to come from and that the file is intact and has not been tampered with in any way. As such, the key pins in the mobile client configuration file are valid and are therefore stored on the mobile client device for later use when establishing an HTTPS connection to the server.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. As used herein, the term “pin” and “key pin” are used interchangeably.

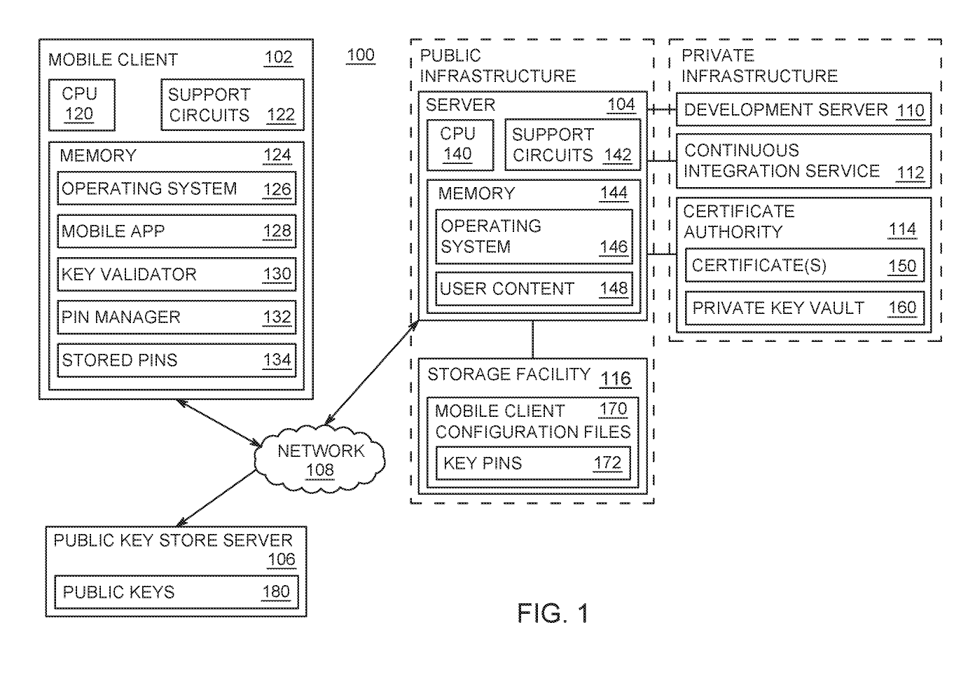

FIG. 1 is a block diagram of a system 100 for securely provisioning HTTPS pins to a mobile client in accordance with one or more embodiments of the invention. The system 100 includes a mobile client 102, a server 104, and a public key storage server 106 communicatively coupled to each other via network 108. In some embodiments, the server 104 provides cloud storage services to a user of the mobile client 102. In some embodiments, the server 104 hosts, maintains, or otherwise interacts with a development server 110, a continuous integration service 112, a certificate authority 114, and a storage facility 116. In some embodiments, one or more of development server 110, continuous integration service 112, certificate authority 114, and storage facility 116 are part of the server 104, while in other embodiments, one or more of the development server 110, continuous integration service 112, certificate authority 114, and storage facility 116 are remote from the server 104. In some embodiments, one or more of the development server 110, continuous integration service 112, certificate authority 114, and storage facility 116 are hosted or maintained by a third-party. The certificate authority 114 manages secure server certificates 150 and the private keys stored in a private key vault 160. The storage facility 116 is used for storing digitally signed mobile client configuration files 170 that include one or more key pins 172. Server 104 and storage facility 170 are part of the cloud storage service's public infrastructure. Development server 110, continuous integration service 112, and certificate authority 114 are part of the cloud storage service's private infrastructure.

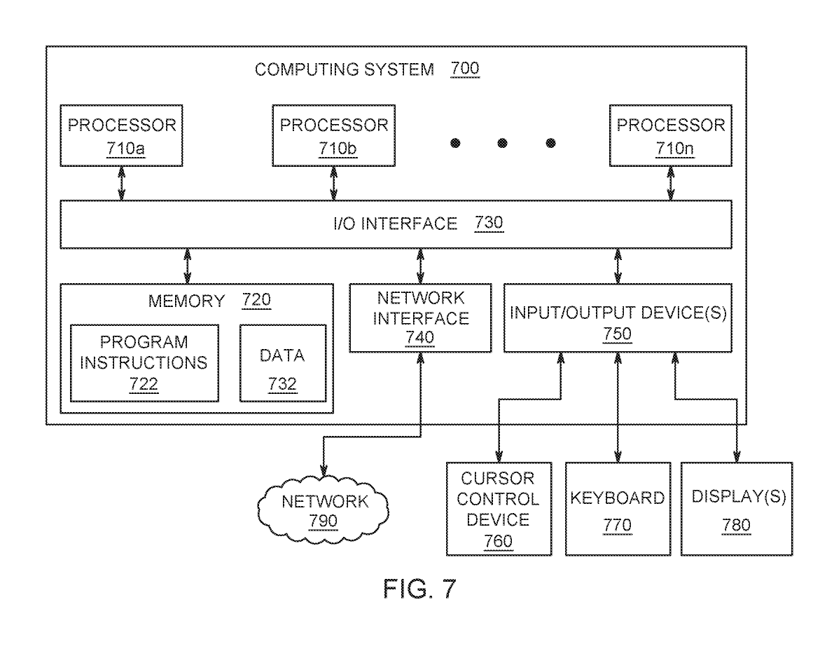

The mobile client 102 may be a type of computing device for example, a mobile device, tablet computer, and the like. One example of a suitable computer is shown in FIG. 7, which will be described in detail below.

The mobile client 102 includes a Central Processing Unit (CPU) 120, support circuits 122, and a memory 124. The CPU 120 may include one or more commercially available microprocessors or microcontrollers that facilitate data processing and storage. The various support circuits 122 facilitate the operation of the CPU 120 and include one or more clock circuits, power supplies, cache, input/output circuits, and the like. The memory 124 includes at least one of Read Only Memory (ROM), Random Access Memory (RAM), disk drive storage, optical storage, removable storage and/or the like. The memory 124 includes an operating system 126, a mobile app 128, a key validator 130, a pin manager 132, and one or more stored pins 134.

The public key storage server 106 includes a plurality of public keys 180, one or more of which may be used by the mobile client 102 to determine the validity of a digital signature.

The server 104 is a computing device, for example, a desktop computer, laptop, tablet computer, and the like, or it may be a cloud based server (e.g., a blade server, virtual machine, and the like). One example of a suitable computer is shown in FIG. 7, which will be described in detail below. According to some embodiments, the server 104 includes a Central Processing Unit (CPU) 140, support circuits 142 and a memory 144. The memory 144 includes an operating system 146, and user content 148 that may be accessed by the user of the mobile client 102 via mobile app 128.

The CPU 140 may include one or more commercially available microprocessors or microcontrollers that facilitate data processing and storage. The various support circuits 142 facilitate the operation of the CPU 140 and include one or more clock circuits, power supplies, cache, input/output circuits, and the like. The memory 144 includes at least one of Read Only Memory (ROM), Random Access Memory (RAM), disk drive storage, optical storage, removable storage and/or the like.

The mobile client 102 and the server 104 may be connected via a network 108, such as a Wide Area Network (WAN) or Metropolitan Area Network (MAN), which includes a communication system that connects computers (or devices) by wire, cable, fiber optic and/or wireless link facilitated by various types of well-known network elements, such as hubs, switches, routers, and the like.

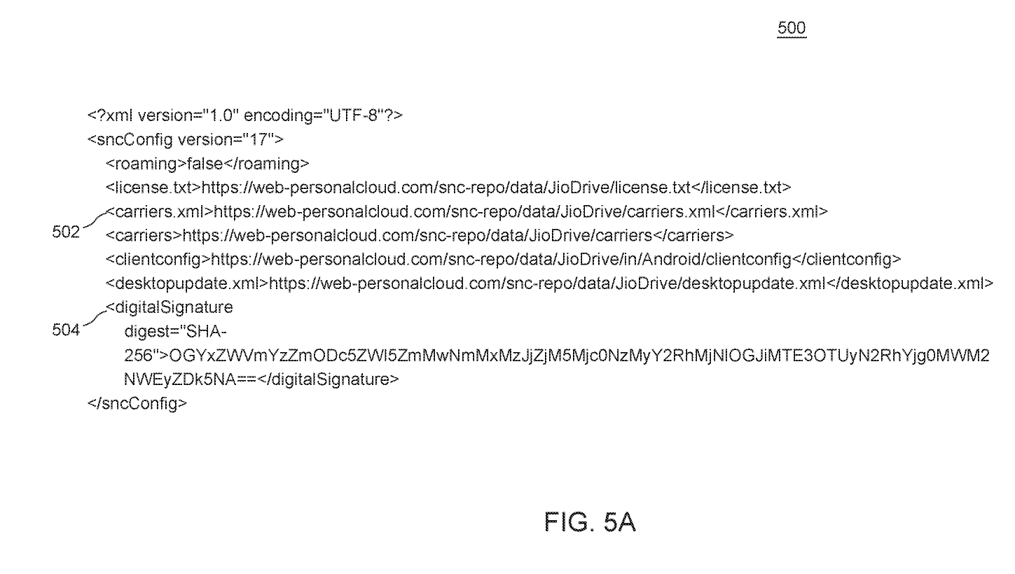

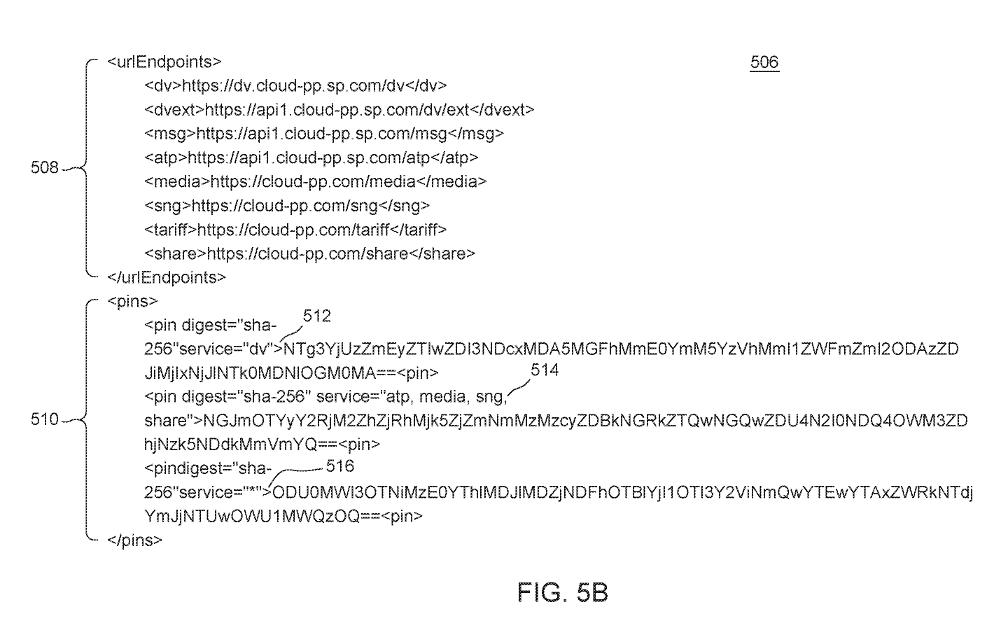

Developers on the development server 110 create a mobile client configuration file 170. The mobile client configuration file 170 includes key pins associated with the secure server certificates 150. In some embodiments, the secure server certificate 150 is an X.509 certificate, which is a standard format for public key certificates. The secure server certificate 150 includes a subject public key information (SPKI) section as part of the secure server certificate 150. A hash is generated from the extracted SPKI information. In some embodiments, the hash is a 256-bit secure hash algorithm (SHA-256) hash, although those skilled in the art will appreciate that any hash algorithm may be used. The hash is then base64 encoded. The 256-bit hash is 2048 characters long. Once it is base64 encoded, the result is 40 characters long. The result is a key pin 172 and is stored in the mobile client configuration file 170. A secure server certificate 150 may exist for each universal resource location (URL) associated with a service on the server 104, as is described in further detail with respect to FIG. 5 below.

After generating the key pins 172 and including the key pins 172 in the mobile client configuration file 170, the mobile client configuration file 170 is sent to the continuous integration service 112. The continuous integration service 112 bundles files for release to the mobile client 102. The continuous integration service 112 sends the mobile client configuration file 170 to the certificate authority 114. The certificate authority 114 accesses the private key vault 160, uses a private key to digitally sign the mobile client configuration file 170, and sends the mobile client configuration file 170 back to the continuous integration service 112. The continuous integration service 112 bundles the mobile client configuration file 170 with other files and stores the bundled files in storage facility 116 for later distribution.

When a user starts the mobile app 128 on the mobile client 102, the mobile app 128 retrieves the mobile client configuration file 170 along with any other files that are bundled together with the mobile client configuration file 170. The mobile client configuration file 170 includes a digital signature. In order to verify the identity of the server 104 and the integrity of the mobile client configuration file 170, the key validator 130 retrieves a public key 180 from the public key storage server 106 and verifies the digital signature on the mobile client configuration file 170. If the digital signature is verified, the pin manager 132 stores the key pins included in the mobile client configuration file 170 as stored pins 134 along with their corresponding URLs from the mobile client configuration file 170.

When a user wishes to access their user content 148 on the server 104, the mobile app 128 establishes a connection to the server 104. The server 104 retrieves their secure server certificate 150 from the certificate authority 114 and sends the secure server certificate 150 to the mobile client 102. The pin manager 132 generates the hash and base64 encoding on the SPKI section of the received secure server certificate 150, as previously described when the key pin was generated for inclusion in the mobile client configuration file 170. The pin manager 132 compares the hashed/encoded SPKI information to the stored pin 134 that corresponds to the URL/certificate 150. If the stored pin 134 matches the hashed/encoded SPKI information, then the secure HTTPS connection is established and user content 148 may be transmitted to the mobile client 102 over the secure connection.

In some embodiments, two pins may be active at any given time. For example, a new backend service HTTPS certificate may be planned for deployment in two weeks' time. A mobile client configuration file 170 may be deployed that includes a current pin and the future pin that would become active in two weeks for that service. In two weeks, when the new secure server certificate 150 is deployed for the new service, the current pin becomes the old pin and the future pin becomes the current pin. After a predefined period of time, the old pin may be removed.

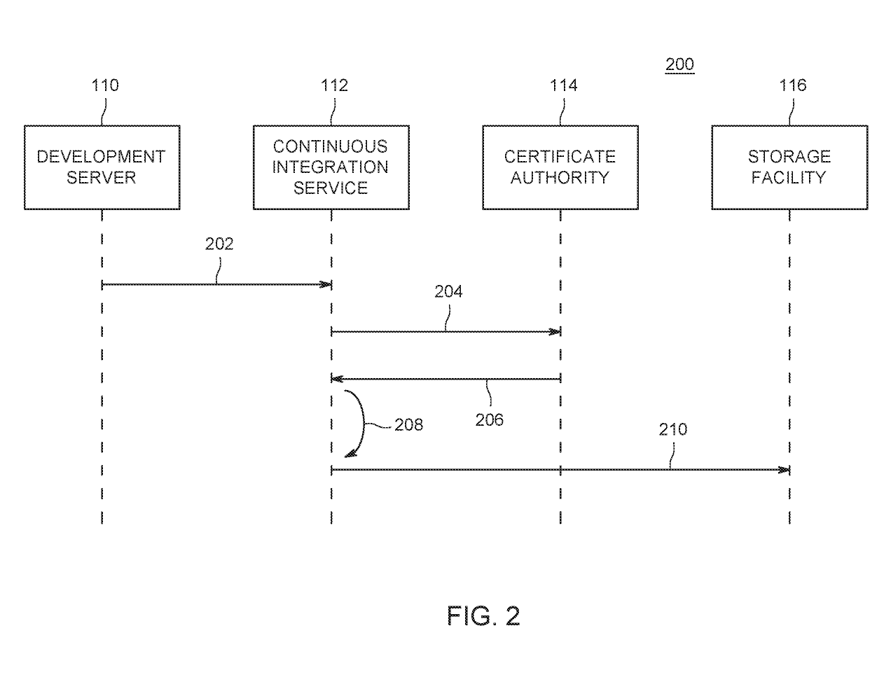

FIG. 2 depicts a method 200 for creating a mobile client configuration file for distribution to a mobile client, in accordance with one or more embodiments of the invention.

At step 202, the development team releases a mobile client configuration file. In some embodiments, the mobile client configuration file is an extensible markup language (XML) file. The mobile client configuration file includes at least one or more key pins associated with secure server certificates associated with the server. The mobile client configuration file is sent from the development server 110 to the continuous integration service 112.

At step 204, the continuous integration service 112 connects to the certificate authority 114 and sends the mobile client configuration file for digital signature. The certificate authority uses the private key stored in the private key vault, and digitally signs the mobile client configuration file.

At step 206, the certificate authority 114 transmits the digitally signed mobile client configuration file back to the continuous integration service 112.

At step 208, the continuous integration service 112 bundles the mobile client configuration file with other files for release to the mobile client. In some embodiments, the bundled file is a .tar file (i.e., a tarball). In some embodiments, the tarball is compressed for distribution.

At step 210, the compressed tarball is stored in storage facility 116 for later distribution. When a mobile client requests a mobile client configuration file, the file is retrieved from storage facility 116.

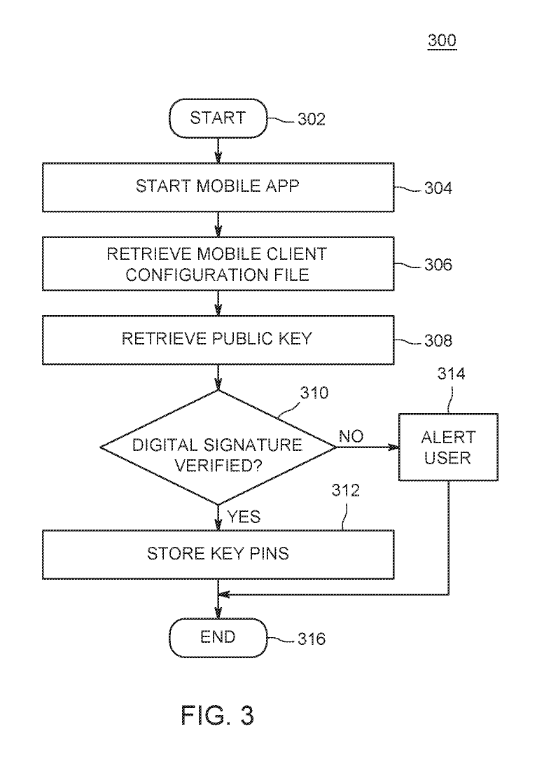

FIG. 3 is a flow diagram of a method 300 for securely provisioning HTTPS pins to a mobile client, in accordance with one or more embodiments of the invention. The method 300 is performed on the mobile client. The method 300 starts at step 302 and proceeds to step 304.

At step 304, the mobile app on the mobile client is started. In some embodiments, the mobile app is an app associated with server. For example, if the server is a cloud server for a content storage service, the mobile app may be the app from where a user requests and views the content. In some embodiments, the mobile app is used to open a secure HTTPS communication channel to the server so the user of the mobile client may request their user content from the server, and have their user content securely transmitted to the mobile client.

At step 306, the mobile app retrieves a mobile client configuration file from the server. The mobile app requests the mobile client configuration file. The mobile client configuration file includes at least one universal resource locator (URL) of the backend server that the mobile client is to connect to. The mobile client configuration file also includes the key pins that are needed to establish the identity of the server. The digitally signed mobile client configuration file is received on the mobile client. In some embodiments, the mobile client configuration file is received from the continuous integration service, which sends the mobile client configuration file associated with the specific user of the mobile client.

At step 308, a public key is retrieved from a public key store server. The public key is used to verify the digital signature of the mobile client configuration file. By verifying the signature, the mobile client establishes that the backend server key pins came from the server that the mobile client expected the pins to come from. Verifying the signature also establishes that the mobile client configuration file is intact and has not been tampered with in any way.

At step 310, it is determined whether the digital signature has been verified. If the digital signature is verified, than at step 312, the key pins in the mobile client configuration file are stored along with the URLs with which they are associated and the method ends at step 316. However, if at step 310, the digital signature is not verified. Then at step 314, the user is alerted. In some embodiments, the user may be prompted whether the user would like to continue even with an unverified mobile client configuration file. In some embodiments, the method proceeds directly to step 316 and ends.

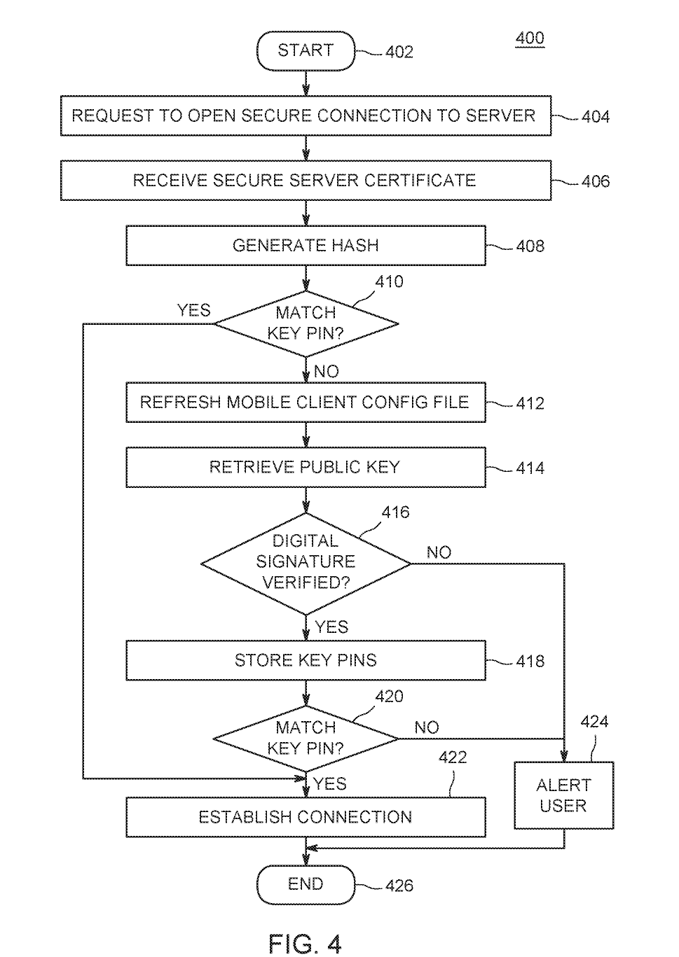

FIG. 4 is a flow diagram of method 400 for opening an HTTPS connection between a mobile client and a server, in accordance with one or more embodiments of the invention. The method 400 starts at step 402 and proceeds to step 404.

At step 404, a request is sent from the mobile app on the mobile client requesting a secure communication channel be opened to the server.

At step 406, a certificate is received from the server. The certificate is a secure server certificate that can be used to verify that the server is in fact the server with which the mobile app expects to communicate. In some embodiments, the certificate is an X.509 certificate, which is a standard format for public key certificates. The certificate includes subject public key information (SPKI) section as part of the certificate.

At step 408, a hash is generated from the SPKI information. The SPKI section is extracted from the certificate. A hash is generated from the SPKI section. In some embodiments, the hash is a 256-bit secure hash algorithm (SHA-256) hash. The hash is then base64 encoded. The 256-bit hash is quite long. Once the hash is base64 encoded, the result is a significantly shorter character string. Due to the fact that the result is compared to the key pin received in the mobile client configuration file, this comparison of fewer characters is much more efficient than a comparison performed just using a 256-bit hash.

At step 410, it is determined whether the hashed and encoded SPKI information matches the key pin stored on the mobile client. If the hashed and encoded SPKI information matches the key pin, then at step 422, a secure HTTPS connection is established between the mobile client and the server.

However, if at step 410, it is determined that the hashed and encoded SPKI information does not match the key pin, the verification information is refreshed. A failure to match the key pin may be the result of a new certificate. If a new certificate was issued, the key pins on the mobile client would be out-of-date and new key pins associated with the new certificate must be retrieved. In order to do this, the mobile client configuration file is refreshed, public keys retrieve, digital signature of the mobile client configuration file verified, and pins stored similarly to the steps described with respect to method 300 above. As such, at step 412, the mobile client configuration file is refreshed, as described at step 306. At step 414, the public key is retrieved from the public key store server. At step 416, it is determined whether the digital signature is verified, and if verified, at step 418, the key pins are stored. If the digital signature is not verified, then method proceeds to step 424 below.

At step 420, it is determined whether the newly acquired key pin matches the hashed and encoded SPKI information. If the information now matches the key pin, then at step 422, the secure HTTPS connection is established between the mobile client and the server.

However, if at step 420, the information still does not match the key pins, or the digital signature could not be verified, then at step 424, the user is alerted. In some embodiments, the user is warned that the network connection has been compromised and the mobile app closes. In some embodiments, the user is warned that their network connection has been compromised, but the user is prompted whether they would like to continue with a compromised connection or whether the user would like to close the mobile app.

The method 400 ends at step 426.

FIGS. 5A and 5B depict an exemplary sncConfig file 500 and a mobile client configuration file 506 for use in a single data center environment, in accordance with one or more embodiments of the invention. In some embodiments, the mobile client configuration file 506 is bundled with other files, such as a sncConfig file 500 that includes a plurality of files that are needed by the mobile client. In some embodiments, the sncConfig file 500 includes a location of a carrier.xml file 502, which includes at least the mobile configuration file 506. In some embodiments, the sncConfig file 500 also includes the digital signature 504. When the digital signature 504 is verified, then all other bundled files listed in the sncConfig file 500 are verified as coming from the server where they were expected. Also, the verified digital signature 504 ensures that all of the bundled files are intact and have not been tampered with. In some embodiments, the user content 148 is stored in server 104 for a data center. In such embodiments, the data center may be the only data center that exists. In such an embodiment, as depicted in FIG. 5B, the mobile client configuration file 506 may include a list of URLs 508 and their associated list of key pins 510. Each URL in the list of URLs 508 corresponds to a backend service. In the present example, services include “dv”, “dvext”, “msg”, “atp”, “media”, “sng”, “tariff”, and “share”. However, there are three HTTPS certificates, one associated with “dv.cloud-pp.sp.com/dv”, a second HTTPS certificate associated with “api1.cloud-pp.sp.com” and a third HTTPS certificate associated with “cloud-pp.com”. Each URL is associated with one or more services. In the present example, “dv.cloud-pp.sp.com/dv”, is associated with a “dv” service, “api1.cloud-pp.sp.com” is associated with a “dvext”, “msg”, “and “atp” service, and finally “cloud-pp.com” is associated with “sng”, “tariff”, and “share” services. In the present example, there are three key pins that exist based on the service. For example, a key pin 512 exists for the service “dv”. The pin 514 is to be used for services “atp, media, sng, and share”. The key pin 516 is for services associated with a “*”, meaning the key pin 516 is to be used for any other service that does not already have a key pin listed. Each key pin 512, 514, and 516 also includes the hash algorithm (e.g., SHA-256), that was used to generate the key pin 512, 514, and 516.

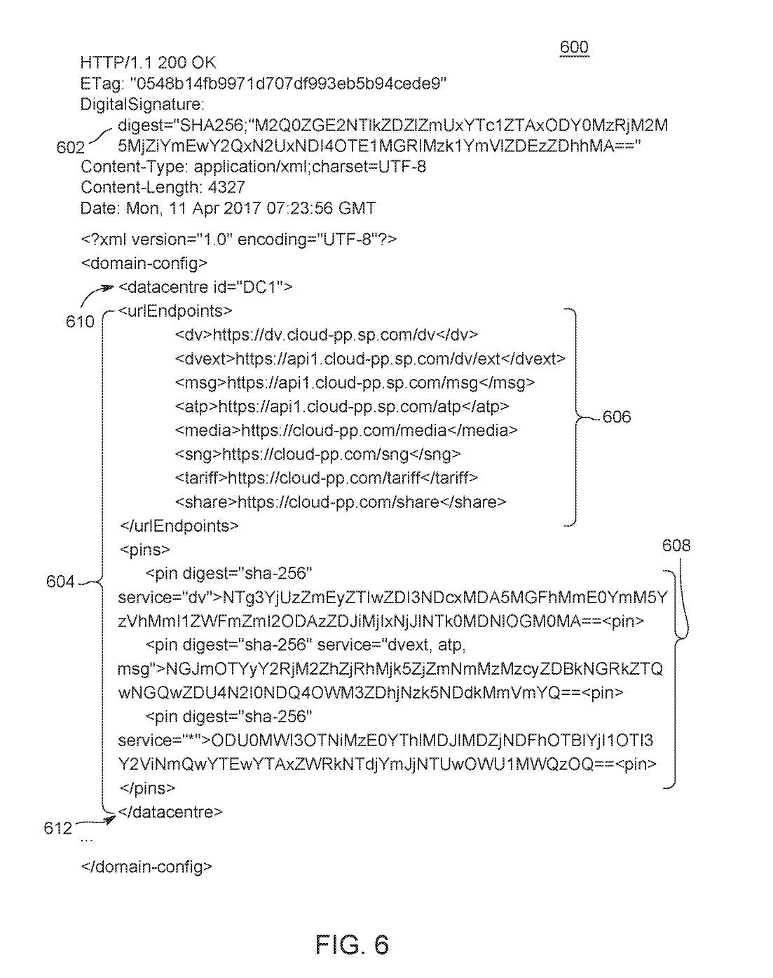

FIG. 6 is an exemplary HTTP response message returned in response to a request for a mobile client configuration file 600 as used in a multi-data center environment, in accordance with one or more embodiments of the invention. In a multi-data center environment, a first user may be connected to a data center in California. The first user may wish to share content (i.e., a link) with a second user who is connected to a datacenter in New York. In the single data center environment described in FIG. 5 above, the mobile client configuration file 500 includes only a set of pins for a given datacenter. FIG. 6 depicts an HTTP response message 600 that includes the digital signature 602 returned in the header of the HTTP response 600 with the mobile client configuration file 604 returned in the HTTP body The mobile client configuration file 604 includes the URLS for all datacenters so all of the datacenters may have secure connections. In some embodiments, the digital signature 602 may be returned as an HTTP header with the mobile client configuration file 604 returned in the HTTP body.

In addition, the mobile client configuration file 604 includes a section with URLs 606 and pins 608 for datacenter #1 (DC1) beginning at 610 and ending at 612. The additional data centers' URLs and pins would follow in the mobile client configuration file 604.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk, C#, or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

FIG. 7 depicts a computer system 700 that can be utilized in various embodiments of the present invention to implement the computer and/or the display, according to one or more embodiments.

Various embodiments of method and apparatus for securely provisioning HTTPS pins to a mobile client, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement the methods 200, 300, and 400 as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. In various embodiments, any of the components may be utilized by the system to receive user input described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the operations and methods described above, such as the methods illustrated by the flowchart of FIGS. 2-4. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for securely provisioning Hypertext Transfer protocol secure (HTTPS) pins to a mobile client, comprising:
accessing, at a server, a secure server certificate;
generating a key pin for the secure server certificate;
storing the key pin in a mobile client configuration file for a mobile client; and
digitally signing the mobile client configuration file.

2. The method of claim 1, wherein the secure server certificate is associated with a server at a universal resource locator (URL).

3. The method of claim 2, wherein one or more URLs are associated with one or more services available at the server.

4. The method of claim 3, wherein a key pin is associated with one or more services available at the server.

5. The method of claim 1, wherein generating the key pin comprises:
extracting a subject public key information (SPKI) section of the certificate;
generating a hash of the SPKI section of the certificate; and
base64-encoding the generated hash.

6. The method of claim 1, wherein the file is an extensible markup language (XML) file.

7. The method of claim 1, wherein the certificate is an X.509 certificate and the hash is a 256-hash.

8. A computer-implemented method for securely provisioning Hypertext Transfer Protocol Secure (HTTPS) key pins comprising:
receiving, at a mobile client, a digitally signed mobile client configuration file, wherein the mobile client configuration file comprises one or more URLs and one or more key pins associated with services available from the one or more URLs;
retrieving a public key from a public key store;
verifying a digital signature of the mobile client configuration file using the public key; and
storing the key pins on the mobile client when the digital signature is verified.

9. The method of claim 8, wherein the mobile client configuration file comprises a current key pin and a future key pin.

10. The method of claim 9, further comprising:
waiting for a new secure server certificate to be deployed from a server;
storing the current key pin as an old key pin; and
storing the future key pin as the current key pin.

11. The method of claim 10, further comprising removing the old key pin after a predefined period of time.

12. The method of claim 8, wherein the mobile client configuration file comprises one or more URLs and one or more key pins, wherein the one or more URLs are associated with two or more datacenters.

13. A system for opening a Hypertext Transfer Protocol Secure (HTTPS) connection between a mobile client and a server, comprising:
a server comprising a memory for storing a plurality of secure server certificates and one or more mobile client configuration files; and
a mobile client comprising:
a) at least one processor;
b) at least one input device; and
c) at least one storage device storing processor-executable instructions which, when executed by the at least one processor, perform a method to:
request to establish an HTTPS connection to the server;
receive a secure server certificate;
extract a subject public key information (SPKI) section of the secure server certificate;
generate a hash from the extracted SPKI section of the secure server certificate;
base64-encode the generated hash;
compare the base64-encoded hash to a key pin stored on the mobile client, wherein the key pin is associated with a URL associated with the server; and
establish the HTTPS connection between the mobile client and the server when the key pin and base64-encoded hash match.

14. The system of claim 13, wherein the processor-executable instructions further perform the method comprising:
requesting a new mobile client configuration file from the server when the key pin and base64-encoded hash do not match;
receiving the new mobile client configuration file from the server;
retrieving a public key from a public key store;
verifying a digital signature of the mobile client configuration file using the public key;
storing the key pins on the mobile client when the digital signature is verified;
compare the base64-encoded hash to the key pin received in the new mobile client configuration file; and
establish the HTTPS connection between the mobile client and the server when the key pin received in the new mobile client configuration file and base64-encoded hash match.

15. The system of claim 14, wherein the processor-executable instructions further perform the method comprising:
displaying an alert to a user that the requested connection has been compromised when the key pin and base64-encoded hash do not match; and
closing the connection between the mobile client and the server.

16. The system of claim 14, wherein the processor-executable instructions further perform the method comprising:
displaying an alert to a user that the requested connection has been compromised when the key pin and base64-encoded hash do not match; and
providing the user an option to continue to communicate with the server with a compromised connection.

17. A non-transitory computer readable medium for storing computer instructions that, when executed by at least one processor causes the at least one processor to perform a method for securely provisioning HTTPS pins to a mobile client, comprising:
receiving, at a mobile client, a digitally signed mobile client configuration file, wherein the mobile client configuration file comprises one or more URLs and one or more key pins associated with services available from the one or more URLs;
retrieving a public key from a public key store;
verifying a digital signature of the mobile client configuration file using the public key; and
storing the key pins on the mobile client when the digital signature is verified.

18. The non-transitory computer readable medium of claim 17, wherein the mobile client configuration file comprises a current key pin and a future key pin.

19. The non-transitory computer readable medium of claim 18, further comprising:
waiting for a new secure server certificate to be deployed from a server;
storing the current key pin as an old key pin; and
storing the future key pin as the current key pin.

20. The non-transitory computer readable medium of claim 19, wherein the mobile client configuration file comprises one or more URLs and one or more key pins, wherein the one or more URLs are associated with two or more datacenters.
